(19) United States
(12) Patent Application Publication
(10) Pub. No.: US 2007/0174543 A1
(43) Pub. Date: Jul. 26, 2007

(54) High-security mask ROM and data scramble/descramble method thereof

(75) Inventor: Sang-bum Kim, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/644,241

(22) Filed: Dec. 22, 2006

(30) Foreign Application Priority Data
Jan. 20, 2006 (KR) 10-2006-0006292

(51) Int. Cl. G06F 12/00

(52) U.S. Cl. 711/102

(57) ABSTRACT

Provided are a high-security mask read-only memory (ROM) in which code data stored in a mask ROM cell array is prevented from being physically hacked, and a mask ROM data scramble/descramble method thereof. In the high-security mask ROM and the mask ROM data scramble/descramble method, a data scramble seed is changed not only according to ROM code data but also whenever an externally supplied ROM address is changed. Accordingly, it is possible to prevent the data scramble seed from being disclosed, and the code data stored in the mask ROM cell array from being physically hacked, thereby significantly increasing security for the ROM code data.

### CROSS-REFERENCE TO RELATED PATENT APPLICATIONS

This application claims the priority of Korean Patent Application No. 10-2006-0006292, filed on Jan. 20, 2006, in the Korean Intellectual Property Office, the disclosure of which is incorporated herein in its entirety by reference.

### FIELD OF THE INVENTION

The present invention relates generally to a mask read-only memory (ROM), and more particularly, to a high-security mask ROM and mask ROM data scramble/descramble methods.

### BACKGROUND OF THE INVENTION

In systems that use a memory (particularly, a mask read-only memory (ROM)), some type of security is typically required to prevent code data stored in a mask ROM from being physically hacked.

FIG. 1 is a schematic block diagram illustrating a path in which data is read from a conventional mask ROM. During a read operation, in the conventional mask ROM, code data is read from a mask ROM cell array 11 via a sense amplifier 13 and a system bus 15. The mask ROM cell array 11 and the sense amplifier 13 are located in a memory region 100, and the system bus 15 is located in a peripheral circuit region (logic region) 110.

However, data scrambling is not performed in the conventional mask ROM, thus making it difficult to prevent the code data stored in mask ROM cell array 11 from being physically hacked. That is, in the conventional mask ROM, it is possible to dump the code data by monitoring an output of the sense amplifier 13, or a bit line (not shown) or a data line (not shown). Also, in the case of a mask ROM that uses metal contact, it is possible to interpret the code data by analyzing a contact layer.

### SUMMARY OF THE INVENTION

The present invention provides a high-security mask ROM that prevents code data stored in a mask ROM cell array from being physically hacked.

The present invention also provides a mask ROM data scramble/descramble method for preventing code data stored in a mask ROM cell array from being physically hacked.

According to some embodiments of the present invention, there is provided a mask read-only memory (ROM) comprising a mask ROM cell array; a data scramble seed generator generating a data scramble seed from a combination of a code seed corresponding to code data coded in the mask ROM cell array, and an externally supplied ROM address; and a data decryption circuit decrypting the code data read from the mask ROM cell array, and outputting the decryption result in response to the data scramble seed.

The data scramble seed is changed according to the ROM address. The data scramble seed is preferably generated by performing an exclusive OR operation on the code seed and the ROM address. Otherwise, the data scramble seed may be generated by adding the code seed and the ROM address.

According to some embodiments of the present invention, there is provided a method of scrambling and descrambling mask read-only memory (ROM) data, the method comprising coding code data in a mask ROM cell array, and embodying a code seed corresponding to the code data in a region other than the mask ROM cell array; generating a data scramble seed from a combination of the code seed and an externally supplied ROM address; and decrypting the code data read from the mask ROM cell array and outputting the decryption result by using the data scramble seed.

The data scramble seed is changed according to the ROM address. The data scramble seed may be generated by performing an exclusive OR operation on the code seed and the ROM address. Otherwise, the data scramble seed may be generated by adding the code seed and the ROM address.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a schematic block diagram of a data read path in a conventional mask ROM;

FIG. 2 is a block diagram of a path in which data is read from a high-security mask ROM according to an embodiment of the present invention; and

FIG. 3 is a flowchart illustrating a mask ROM data scramble/descramble method performed in the mask ROM of FIG. 2, according to some embodiments of the present invention.

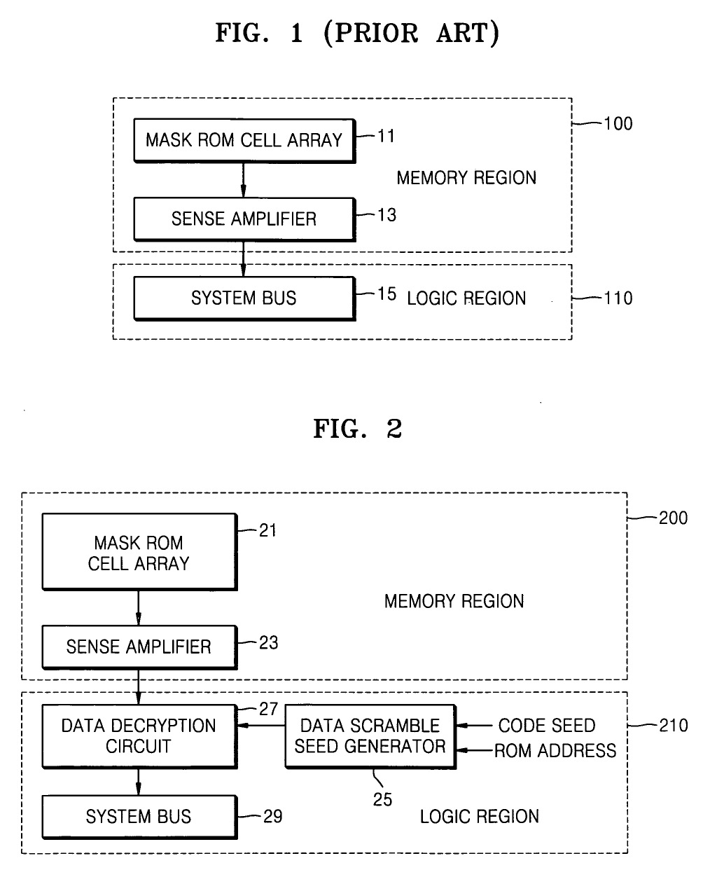

### DETAILED DESCRIPTION OF THE INVENTION

Hereinafter, exemplary embodiments of the present invention will be described in detail with reference to the accompanying drawings.

FIG. 2 is a block diagram of a path in which data is read from a high-security mask read-only memory (ROM) according to an embodiment of the present invention. Referring to FIG. 2, the high-security mask ROM includes a mask ROM cell array 21, a sense amplifier 23, a data scramble seed generator 25, a data decryption circuit 27, and a system bus 29.

The mask ROM cell array 21 and the sense amplifier 23 are arranged in a memory region 200, and the data scramble seed generator 25, the data decryption circuit 27, and the system bus 29 are arranged in a peripheral circuit region (a logic region) 210.

During a manufacturing process, code data that a user provides is stored in the mask ROM cell array 21. In particular, the data scramble seed generator 25 is manufactured to generate a data scramble seed from a combination of a code seed corresponding to the code data coded in the mask ROM cell array 21, and an externally applied ROM address.

Accordingly, in a mask ROM according to some embodiments of the present invention, the data scramble seed is changed not only according to the code data but also according to a ROM address change whenever the mask ROM cell array 21 is accessed. Therefore, it is possible to prevent the data scramble seed from being disclosed, thereby significantly improving security for ROM code data.

More specifically, according to the characteristics of conventional mask ROMs, a data scramble seed cannot be differently set for each chip, but a mask must also be changed when ROM code data stored in a ROM is changed. Therefore, a mask ROM according to an embodiment of the present invention is constructed to generate a data scramble seed by using a changed mask, i.e., a code seed corresponding to ROM code data. In this way, the data scramble seed can be changed according to the ROM code data, thereby improving security for the ROM code data.

The code seed is embodied to have a different value for each ROM code data by using a ROM coding mask, and is located in the logic region 210. However, it is possible to obtain the code seed through decapping and visual analysis of the mask ROM. Thus, when the data scramble seed is generated by using only the code seed, the data scramble seed may be disclosed, thus lowering security for the ROM code data.

Accordingly, in a mask ROM according to an embodiment of the present invention, the data scramble seed is generated by using both the code seed and an externally supplied ROM address to improve security for the ROM code data. That is, as described above, the data scramble seed generator 25 generates the data scramble seed from a combination of the code seed corresponding to the ROM code data, and the externally supplied ROM address.

Accordingly, in a mask ROM according to an embodiment of the present invention, the data scramble seed is changed not only according to the code data but also according to the ROM address change whenever the mask ROM cell array 21 is accessed. Therefore, it is possible to prevent the data scramble seed from being disclosed, thereby significantly improving security for the ROM code data.

Alternatively, the data scramble seed generator 25 may generate the data scramble seed by performing an exclusive OR operation on the code seed and the ROM address. Otherwise, the data scramble seed generator 25 may generate the data scramble seed by adding the code seed and the ROM address.

The data decryption circuit 27 decrypts the code data read from the mask ROM cell array 21 in a read operation and outputs the decrypting result in response to the data scramble seed. The decrypting result is output via the system bus 29.

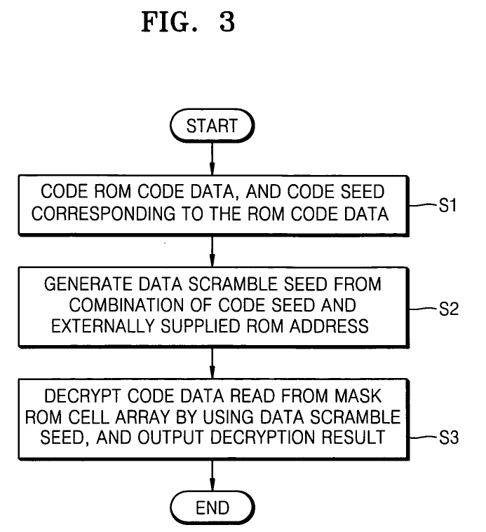

FIG. 3 is a flowchart illustrating a mask ROM data scramble/descramble method performed in the mask ROM of FIG. 2, according to some embodiments of the present invention. The method of FIG. 3 includes operations S1 through S3. Referring to FIGS. 2 and 3, first, in operation S1, code data is coded in the mask ROM cell array 21 by using a ROM coding mask, and a code seed corresponding to the code data is embodied in the logic region 210. In this case, whenever the code data is changed, the code seed is also changed.

Next, in operation S2, a data scramble seed is generated from a combination of the code seed and an externally supplied ROM address. The data scramble seed may be generated by performing the exclusive OR operation on the code seed and the ROM address. Alternatively, the data scramble seed may be generated by adding the code seed and the ROM address. The data scramble seed is generated by the data scramble seed generator 25.

Next, in operation S3, code data read from the mask ROM cell array 21 in a read operation is decrypted by using the data scramble seed, and the decrypting result is output.

As described above, in a mask ROM data scramble/descramble method according to some embodiments of the present invention, a data scramble seed is generated from a combination of a code seed and an externally supplied ROM address. Thus, according to the mask ROM data scramble/descramble method, the data scramble seed is changed not only according to code data but also according to a ROM address change whenever a mask ROM cell array is accessed. Therefore, it is possible to prevent the data scramble seed from being disclosed, thereby significantly improving security for ROM code data.

As described above, in a mask ROM and a mask ROM data scramble/descramble method according to the present invention, a data scramble seed is changed not only according to ROM code data but also a ROM address is changed whenever an externally supplied ROM address is changed. Therefore, it is possible to prevent the data scramble seed from being disclosed, thereby preventing code data stored in a mask ROM cell array from being physically hacked. Accordingly, it is possible to significantly improve security for ROM code data.

The specific terms used in the present disclosure are not intended to restrict the scope of the present invention and only used for a better understanding of (to facilitate the understanding of) the present invention. It will be understood by those skilled in the art that various changes in form and details may be made without departing from the spirit and scope of the invention as defined by the appended claims.

What is claimed is:

1. A mask read-only memory (ROM) comprising:
a mask ROM cell array;
a data scramble seed generator that generates a data scramble seed from a combination of a code seed corresponding to code data coded in the mask ROM cell array, and an externally supplied ROM address; and
a data decryption circuit that decrypts the code data read from the mask ROM cell array and outputs the decryption result in response to the data scramble seed.

2. The mask ROM of claim 1, wherein the data scramble seed is changed according to the ROM address.

3. The mask ROM of claim 1, wherein the data scramble seed is generated by performing an exclusive OR operation on the code seed and the ROM address.

4. The mask ROM of claim 1, wherein the data scramble seed is generated by adding the code seed and the ROM address.

5. A method of scrambling and descrambling mask read-only memory (ROM) data, comprising:
coding code data in a mask ROM cell array, and embodying a code seed corresponding to the code data in a region other than the mask ROM cell array;
generating a data scramble seed from a combination of the code seed and an externally supplied ROM address; and
decrypting the code data read from the mask ROM cell array and outputting the decryption result by using the data scramble seed.

6. The method of claim 5, wherein the data scramble seed is changed according to the ROM address.

7. The method of claim 5, wherein the data scramble seed is generated by performing an exclusive OR operation on the code seed and the ROM address.

8. The method of claim 5, wherein the data scramble seed is generated by adding the code seed and the ROM address.
